(19) United States
(12) Patent Application Publication
(10) Pub. No.: US 2026/0318017 A1
(43) Pub. Date: Oct. 15, 2026

(54) Fully Autonomous Robotic Paving and Crack Sealing System

(71) Applicant: Robopave, Palos Heights, IL (US)

(72) Inventor: Mohyeldin Ragab, Palos Heights, IL (US)

(21) Appl. No.: 19/366,015

(22) Filed: Oct. 22, 2025

Related U.S. Application Data
(60) Provisional application No. 63/787,537, filed on Apr. 11, 2025.

(51) Int. Cl. E01C 23/07; B64U 20/80; B64U 101/26; E01C 23/09

(52) U.S. Cl. CPC E01C 23/07; B64U 20/80; E01C 23/0973; B64U 2101/26

(57) ABSTRACT

The ROBOSEALER is a fully autonomous robotic system for detecting and sealing cracks in road surfaces. It includes a ground-based Robo Vehicle and an aerial RoboDrone, coordinated through scanning and sealing subsystems. The scanning subsystem uses deep learning to detect and localize cracks from aerial imagery, generating a crack map for the RoboVehicle. The sealing subsystem performs optimized path planning, crack volume estimation, debris removal, and precision sealing using a five-bar nozzle mechanism. The Robo Vehicle features integrated heating, agitation, and sealant dispensing systems, as well as wireless drone charging and a user-friendly HMI. The analysis system provides cloud-based data storage, model training, performance monitoring, and road condition forecasting. The port and station modules enable automated sealant refilling, including retrofitting of existing melters. The RoboDrone features autonomous navigation, onboard analysis, and wireless charging. Together, these components deliver a scalable, intelligent, and efficient road maintenance solution.

The current application claims a priority to the U.S. Provisional Patent application Ser. No. 63/787,537 filed on Apr. 11, 2025.

### FIELD OF THE INVENTION

The present invention relates generally to the paving and sealing of roads. More specifically, the present invention relates to autonomous crack sealing solution. Specifically, the present invention is an autonomous crack sealing solution capable of autonomous navigation and crack sealing.

### BACKGROUND OF THE INVENTION

Road maintenance is an expensive and time-consuming field of work. Existing road maintenance technologies require a great deal of man-hours and effort to ensure roads are properly maintained, especially for areas such as crack sealing. Thus, there exists a need for a more efficient way to clean and maintain pavement, asphalt, and roadways.

The present invention aims to solve this problem by creating a fully autonomous robot (hereinafter “ROBOSEALER”) capable of detecting, cleaning, and sealing cracks in pavement. The present invention uses three robots, Robo Vehicle, RoboDrone and Smart truck, each robot runs specific systems to achieve its tasks. RoboDrone runs the SmartScan system, Robo Vehicle runs SealBest system, and Motherstation has SmartPort system, and each system includes multiple modules, other supplementary systems can be used to add features to the invention such cloud's Forecasted Age Analysis of Pavement (FAAP).

The modular design of the ROBOSEALER solution allows for easy upgrades and feature additions while also enabling the development of new solutions using pre-designed modules.

In one embodiment, ROBOSEALERs may be fitted to perform other operations, such as tack coating, slurry seal or perform cleaning operations, such as garbage pickup, cigarette butt pickup, and other waste pickup either found on the highway, roads, or sideway of highway and roads.

In this way, an efficient, convenient solution for road and pavement maintenance, garbage collection, and cleaning is disclosed by the present invention that allows for improved safety, cleaner roads, increased efficiency, savings, fewer personnel requirements, and reduced equipment needs.

### BRIEF DESCRIPTION OF THE DRAWINGS

FIG. 1 is a diagram of the ROBOSEALER Subsystems.

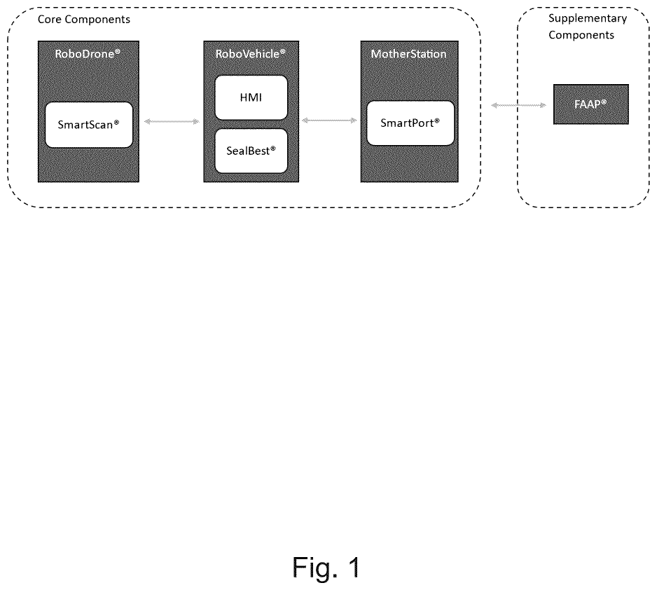

FIG. 2A shows the RoboDrone.

FIG. 2B shows the Robo Vehicle.

FIG. 3 is a diagram of the SmartScan architecture.

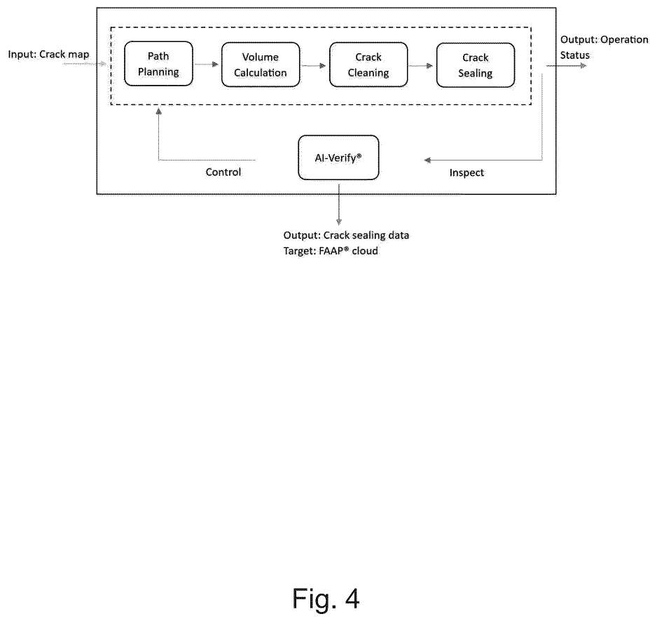

FIG. 4 is a diagram of the SealBest architecture.

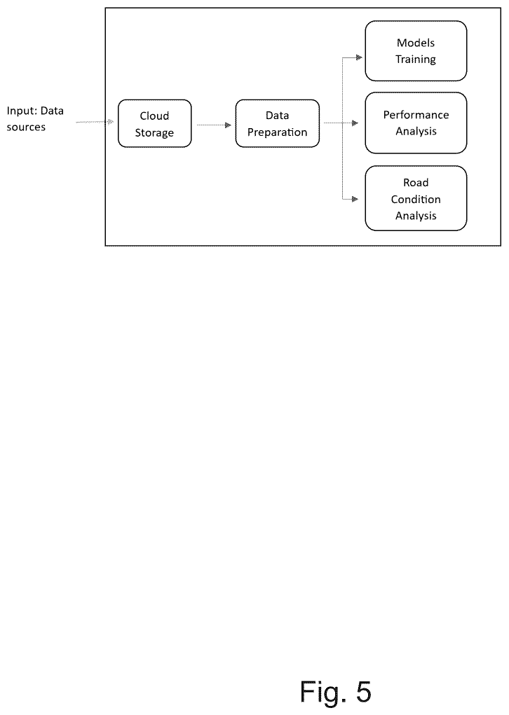

FIG. 5 is a diagram of the FAAP architecture.

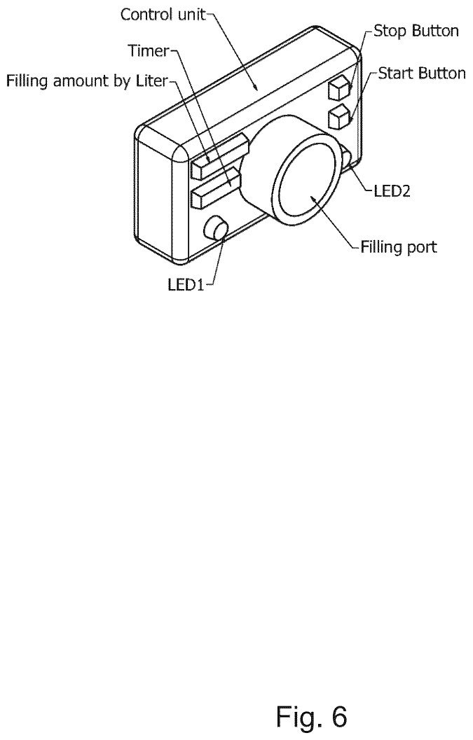

FIG. 6 shows the SmartPort and its components.

FIG. 7 shows an embodiment of the SmartTruck.

FIG. 8 shows an embodiment of the MotherStation with a single driver.

FIG. 9 shows the RoboDrone and its components.

FIG. 10 shows the Robo Vehicle and its components.

FIG. 11 shows the heating elements module.

FIG. 12 shows the wheel unit driving sequence.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is it to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a robotic paving and crack sealant system, embodiments of the present disclosure are not limited to use only in this context.

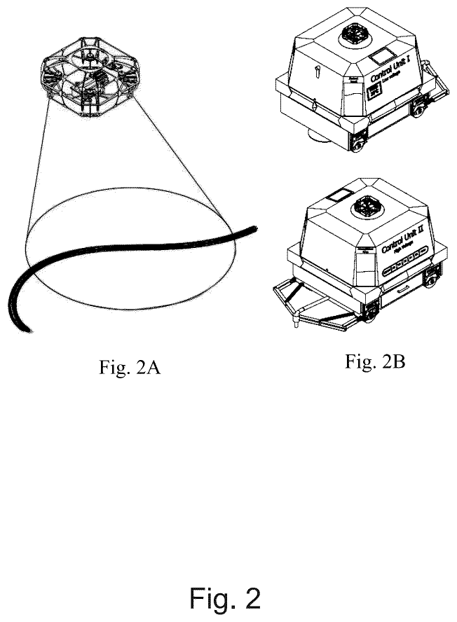

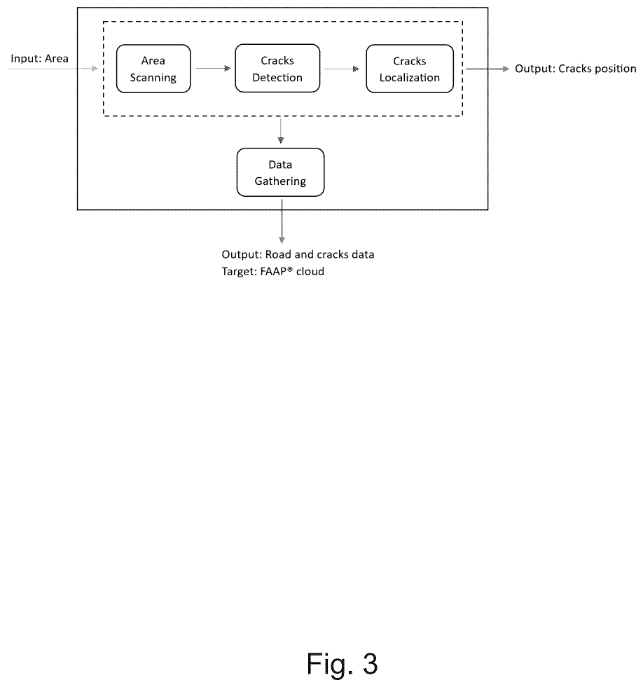

The ROBOSEALER is an advanced robotic solution designed for efficient crack detection and sealing operations. It comprises two main robotic units: RoboVehicle, a fully autonomous mobile robot, and RoboDrone, an aerial drone as shown in FIG. 2.

The RoboDrone is equipped with the SmartScan subsystem, which scans designated areas, detects cracks, and transmits the data to the RoboVehicle.

Once cracks are identified, RoboVehicle, integrated with the SealBest system, autonomously performs the sealing operation, ensuring effective repair.

All data collected and processed by the ROBOSEALER system is communicated to the FAAP system, where it is stored and analyzed to enhance operational efficiency, faults detection, and long-term infrastructure forecasting.

### SmartScan System

The SmartScan system is designed to achieve fast and accurate road inspection. The system uses RoboDrone to achieve fast inspection, but it can be installed and operated entirely on the RoboVehicle.

The system starts operation by receiving work area from an operator, the area is sent to SmartScan area scanning module as closed polygon their corners are the coordinates, the module generates optimized path to cover the whole area, with cutting edge camera fixed on the drone, the module collects road images and sends them to cracks detection module.

The cracks detection module uses ROBOSEALER AI, a state-of-the-art deep learning model designed to precisely detect cracks, if crack exist in the image, it's sent to crack localization module.

The cracks localization module determines the exact position of crack; it builds a map with all cracks detected in the work area which will be sent to SealBest system.

For analysis, model and service improvements ROBOPAVE collects raw data and uploads it to FAAP cloud service where analysis, model training and forecasting are performed.

### Design Details

The first step in the process is a user friendly interface that enables operators to interact with the system, the ROBOSEALER comes with an easy to use HMI that embodies illustrations and graphics, the HMI provides a straightforward and easy operation experience, where a map of the robot current location will appear on the screen and the operator just draws a polygon on the area of interest that needs to be worked on “work area” and the robot will handle the rest of the work.

The SMARTSCAN system receives the coordinates of polygon, an optimized path is created to cover the whole area with the minimum time, the algorithm takes into consideration many parameters, the area of the polygon, the weather condition, and lighting condition (RoboDrone adjust its flight height based on these parameters).

SmartScan solution has two implementation, a drone implementation (RoboDrone), and onboard implementation (Wide camera).

It adds redundancy to the robosealer, so it can work normally if one of the implementations has serious issue, it also enables the usage of robosealers in military applications.

The wide camera hardware consists of camera with depth vision, and light source. The wide camera is mounted on top of the robot. It leverages the same core technology as Drone implementation, with minor adaptations in the detection handling algorithms. Camera capture frame, deep learning model detects cracks, if there are cracks detected, the module runs algorithm that converts cracks from camera to real world position, and prioritizes sealing operation.

RoboDrone starts its flight mission with advanced lighting system and HD camera, each captured frame is input into the crack detection module, at the end of flight mission, a map of the whole area with detected cracks is created and ready to be used in the next phase of the operation.

ROBOSEALER AI module is a CNN (Convolutional Neural Network) segmentation deep learning trained and optimized using customized data collected by ROBOPAVE's team to achieve higher accuracy. The model is periodically tuned with new data to enhance accuracy to exceed 95%.

When a sequence of detected crack masks is sent to crack localization module, it performs specific predetermined processes on the mask to extract the center line of the crack. It then uses triangulation methods to extract the 3D position of crack pixels. After that it uses the kinematics to get points in the world frame “map frame”. Each mask is processed separately, and each output is used to build one map for the work area with all detected cracks locations. This final result of analysis would be called a crack map and would be then received by RoboVehicle to start sealing operation.

### SealBest System

The SealBest system is responsible for the sealing of the cracks on the road with minimum material waste, maximum sealing speed, and highest accuracy.

The system starts by receiving the cracks' map from the SealBest system, the path planning module uses advanced algorithms to do specific predetermined processes on the map that results in the determination of the optimum path for sealing all cracks detected.

After the path plan creation, the RoboVehicle follow the predetermined optimum path. When the RoboVehicle reaches the crack start point, the volume calculation module calculates the volume. This information is then used by the ROBOSEALER to determine how much sealant to pour into the crack.

The next step in the process is the cleaning module. The cleaning module removes debris from the cracks to ensure proper adhesion at the sealing stage.

The sealing module includes advanced mechanical systems that provide flexibility to the nozzle. Such systems enable the nozzle to follow the cracks and to pour proper amount of sealant to repair the cracks.

The AI-Verify module plays a crucial role in verifying the sealing efficiency and sending correction commands to SealBest system to redo the failed steps if existent.

### Design Details

The path planning module is designed to ensure optimized sealing time. To achieve this task, an advanced algorithm is used. The algorithm analyzes the cracks' map, extracts specific features, the extracted features are then used to rank cracks' priorities.

Below are the algorithm's steps:
1. The number of cracks are extracted as well as the length of each crack.
2. Using graph structure, the cost function of the different paths is computed.
3. Based on the cost function of the different paths, the fastest path is selected.

When the path plan is ready, the RoboVehicle moves to the first crack, at this point, the volume calculation module takes control.

The volume calculation module follows the crack and captures the crack's 3D pointcloud using depth imagery. The depth imagery is processed using pointcloud processing techniques to build the crack 3D structure and extract its volume, the crack volume is then sent to the nozzle mechanism to control the sealant amount.

The crack sealing module uses a five-bar mechanism to add flexibility to the nozzle, the module receives the crack's location and its volume, it also guides the RoboVehicle's motion to ensure that the crack is within the nozzle's reachable area. If a crack is reachable by the nozzle, the module starts the sealing process, it controls the nozzle's pump to pour the optimum sealant amount for the crack under work, it also guides the mechanism to follow the crack's center line avoiding waste sealant outside crack.

Verification is an important part in any autonomous system, it enables designers to refine and enhance the system, besides making the system correct itself and recovering from unsuccessful attempts.

The AI-Verify module is a customized deep learning model, trained on data collected specifically for it, it uses a cutting edge camera fixed at the back of RoboVehicle.

The module monitors the sealing operation quality, it detects sealing faults, and it can pause the sealing operation and guides robot to reseal the failed portion of the crack.

### FAAP System

The FAAP system provides complete data driven insights and performance improvement. This is done through the utilization of the large amount of data collected during each operation of the ROBOSEALER system. This data is then employed to accelerate operation development.

The FAAP enables the ROBOSEALER to learn from vast datasets, refining its actions and reducing errors, FAAP relies on cloud infrastructure and its services, it automates data pipeline with little human intervention.

The system comprises cloud storage capable of accommodating terabytes of data as well as a DPM (Data Preparation Module) that automates data cleaning and preprocessing.

The MTM (Models Training Module) is responsible for the training of the ROBOPAVE AI and AI-Verify models periodically and it provides reports of the current improvements in the model in addition to any other discovered issues.

The PAM Performance Analysis Module) monitors the performance of ROBOSEALER systems. It provides real-time insights into system performance, detects potential faults or inefficiencies, and alerts the development team for timely intervention. This ensures optimal functionality, reliability, and longevity of the ROBOSELAER operations.

The RCAM (Road Condition Analysis Module) is designed to assess the current state of roads using image-based analysis. This module utilizes computer vision and machine learning techniques to process images of road surfaces, indicates condition before and after sealing operation, and predicts the remaining lifespan of the road.

### Design Details

The CSM (Cloud Storage Module) is a high-capacity data management component designed to accommodate terabytes of data. It serves as the backbone for storing and organizing diverse datasets, including road images, sensor data, and robot logs. This structured approach ensures efficient storage, retrieval, and processing of data for deep learning training, real-time analytics, and system monitoring. It is designed to scale horizontally, allowing storage expansion as data volume grows.

The CSM is implemented with encryption and role-based access to ensure data privacy and security.

The CSM is divided into different repositories based on data type and usage to ensures optimized access and management of diverse datasets such as:
Road images: Captured from the RoboDrone and the RoboVehicle
Sensor's data: Collected from a vast range of sensors used in the ROBOSELAER (e.g., Lidar, radar, etc.)
Logs and meta data: Performance logs, error reports, and operational data.

The DPM is designed to automate data cleaning, preprocessing, and transformation. It works in conjunction with the CSM to ensure that raw data such as road images, sensor logs, and robot performance data is refined, structured, and ready for analysis for machine and deep learning model's optimization.

Raw data undergoes preprocessing before storage to improve quality. This includes removing noise, labeling images for deep learning training, and structuring data for easy retrieval.

Output data is stored in different specialized storage solutions based on its format:
Sensor readings, robot performance logs, metadata, and tabular datasets are stored in SQL-based relational databases.
Large-scale road images and labels are stored in object storage.
Real-time sensor readings, telemetry data, and robot health parameters are stored in time-series databases.

The MTM, PAM, and RCAM rely on high-quality, cleaned data provided by the DPM to ensure accurate, efficient, and reliable results. The processed data fuels these modules, enabling them to serve their intended tasks effectively.

### Remote Monitoring

monitoring system enables client to observe all components of the robosealer in real time and remotely.

System status, operational metrics, and sensor data can be monitored remotely in real time, enabling engineers to manage operations efficiently. The system also provides instant notifications of any issues, allowing immediate action without requiring physical presence near the equipment. Users can conveniently monitor the system through either a web application or a mobile application.

For users managing multiple RoboSealer systems, all units can be tracked in one centralized platform, with seamless navigation between systems for simplified oversight and control.

Remote monitoring has multiple levels of authentication, operator level which monitor basic status and sensors data, admin level which monitor advanced logs, run debugging commands, and remote control the machine.

In admin level, user can start operation from the app without using HMI, user can mark the working area and send start command.

The monitor app brings client's all robosealers in one place to monitor them at the same time, the start up page shows a map with locations of the client's robosealers and their status off/standby/active, the client can choose specific robosealer to monitor it, a new page will open with monitoring data based on the authentication level.

Client get notifications from robosealers, notification includes severity level, and action required if any.

The remote monitoring is user intutive and can run on different platforms, it runs on PCs as web app and on mobile android/ios as mobile app.

### SmartPort

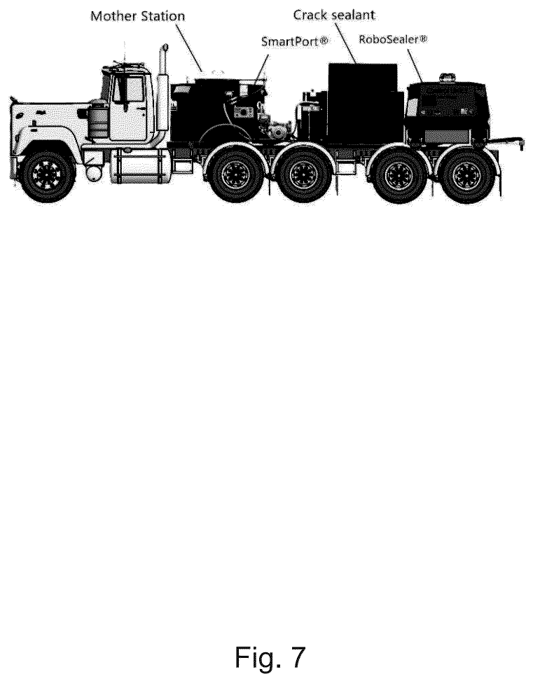

The SmartPort is an add-in module for the Crack melting machine with large capacities that may vary from 100-400 gallons allowing them to interact with, fill, and refill the RoboVehicle. It can be added to any manual crack melters to transform it into a MotherStation. FIG. 6 represents the physical form of SmartPort and its components.

As seen from FIG. 6, the SmartPort comprises:
Control unit: the Control unit contains a GPS, an IMU and a Microcontroller. It enables the communication to the RoboVehicle and control the docking system with the RoboVehicle's filling port. It also controls and calculates the amount of dispensed sealant.
Timer: Indicator how many times the RoboVehicle gets full tank of sealant.
Filling amount by Liter: Indicator for the amount of sealant dispensed during the filling process.
LED 1: Indicator for the docking state.
LED 2: Indicator for the smart port status as either on or off.
Start/Stop button: Emergency Button to run the SmartPort.
Filling port: The port with a docking system to connect to the RoboVehicle.

### MotherStation:

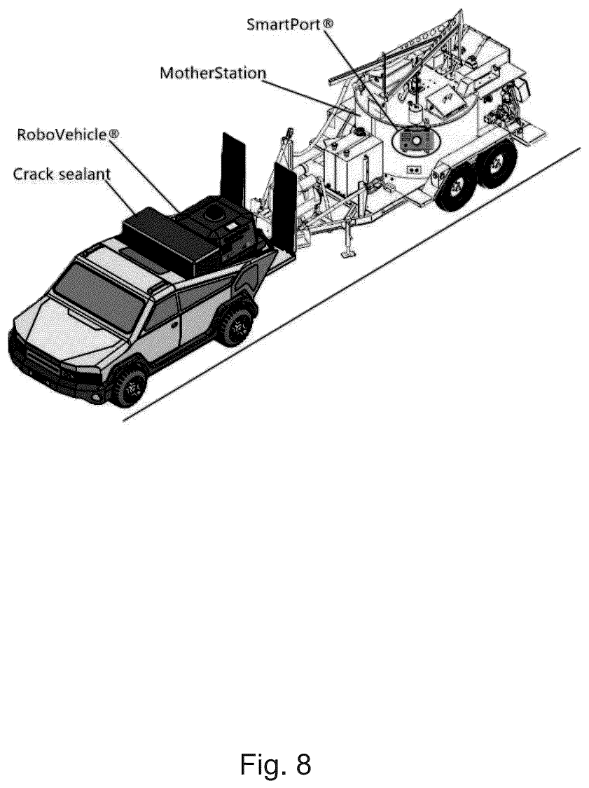

In this solution, two solutions are offered for MotherStation. It can be produced new with all modules included or the old crack melters can be modified to serve as the MotherStation.
A key advantage for the second option mentioned earlier would be to accommodate existing commercial crack melters that can be easily upgraded with minor modifications to include a SmartPort and essential sensors, transforming them into intelligent MotherStations.
In addition to integrating SmartPort into old crack melters, temperature and level sensors are also installed—if not already present in the melter—to enable status monitoring for the MotherStation and eliminate the need for manual intervention, in the next iterations of solution upgrade, Smart truck contain MotherStation will be modified to be fully autonomous by introducing the SelfDriver module. FIG. 7 represents The Smart Truck autonomously delivering the entire solution to work areas, operating without any manual intervention.

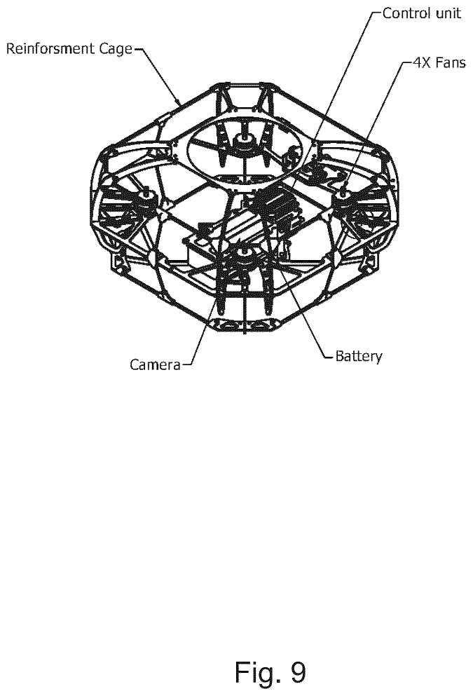

The MotherStation communicates wirelessly with the RoboVehicle to provide the RoboVehicle with relevant location information. The RoboVehicle can navigate to the SmartPort and then attach to the SmartPort to refill the sealant. The SmartPort system can control the flow of crack sealant from the MotherStation to the RoboVehicle by opening and closing a valve. FIG. 8 represents the method of allocating the entire solution using a pickup truck. In this method, only one user is needed to drive and install the system.

### RoboDrone

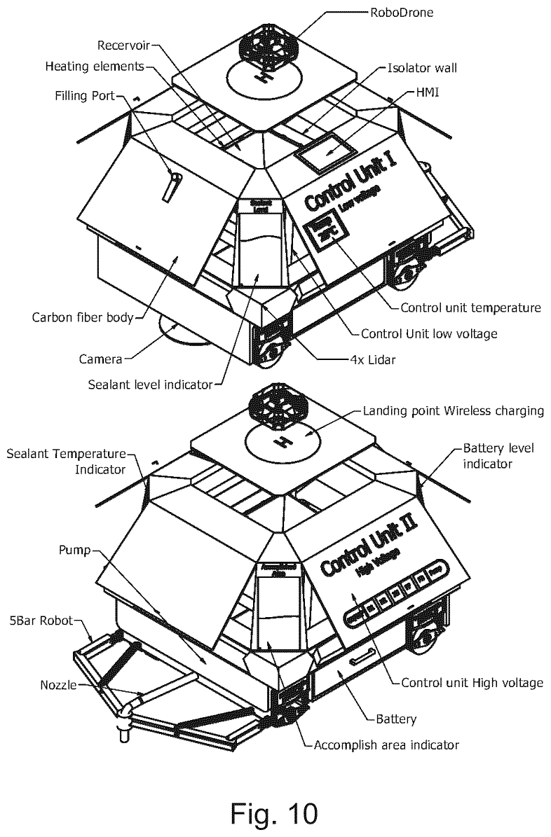

The RoboDrone, shown in FIG. 9, is a fully autonomous drone designed to capture and analyze cracks' shapes and positions while communicating with RoboVehicle to guide it to the cracks' locations.

As seen from FIG. 9, the RoboDrone comprises:
Control unit: Works as the main brain. Controls the four propellers to steer the drone with ANS (Autonomous Navigation System) and analyzes the cracks' images.
Battery: Powers the entire drone and has multiple charging interfaces like the wireless interface to allow for charging from the RoboVehicle. The battery also works as a balance weight.
Camera: This is used to capture the cracks. It also encapsulates a lighting system to work in dark roads.
Four Propellers: The quad copter contains four motors to control the drone height and steer the drone.
Reinforcement Cage: The main chassis, made of carbon fiber to allow for light weight and high strength.

### RoboVehicle

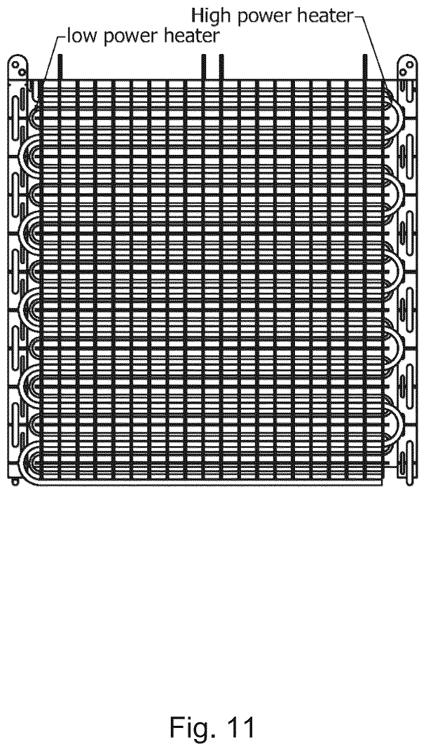

The RoboVehicle, illustrated in FIG. 10 and FIG. 13 representing the two prototype, each one is a fully autonomous mobile robot that is the integration of many subsystems. Every subsystem works with one another in harmony. The main function is to recapture the cracks with volume measurement and seal them with the molten crack sealant. It also works in conjunction with the SmartPort to refill and continue the process.

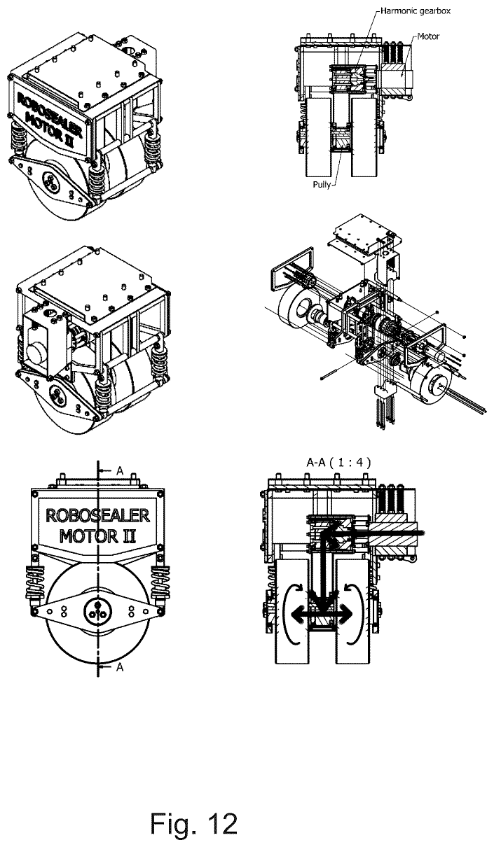

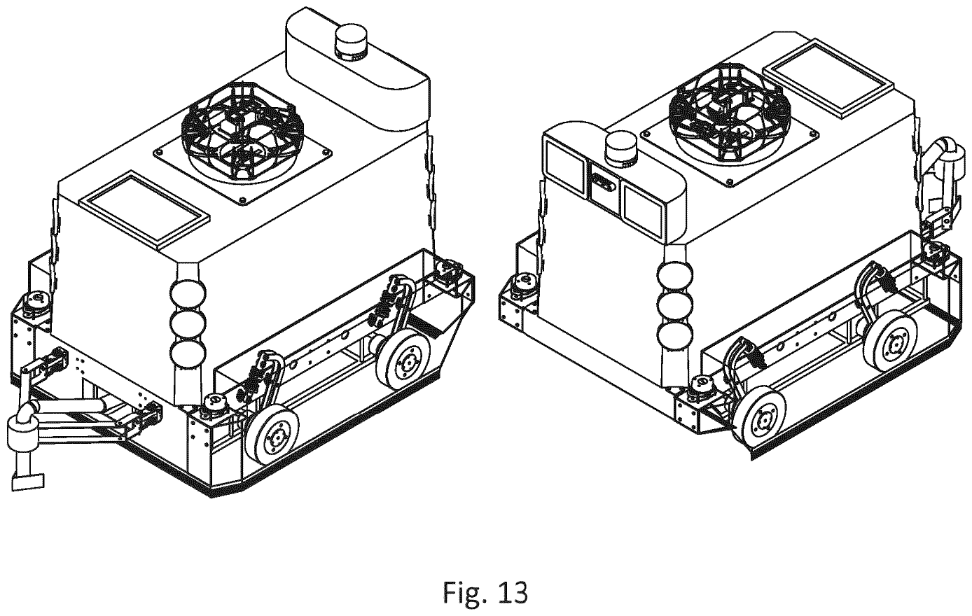

As seen from FIG. 10 and FIG. 13, the RoboVehicle comprises:
HMI: The interface between the user and the RoboVehicle to allow the user to interact with the RoboVehicle to determine the area needed to be sealed. This tablet contains a map to indicate the area to sealed and to start the process.
Filling port: The SmartPort fills the RoboVehicle with sealant by the filling port.
Landing point with wireless charger: Where the RoboDrone lands and gets charged.
Reservoir: Where the sealant is stored. The end of the reservoir has a cone shape structure to deliver the sealant to the pump. An agitation system is also integrated in the reservoir.
Heating Elements: There are two stages of the heating system as shown in FIG. 11. The first stage divides the reservoir to the upper and lower area and use high heating power to melt the blocks of sealant. The second stage also divides the reservoir to upper and lower areas and uses the heating power to maintain the sealant temperature. The heating system is in contact with the four walls of the reservoir. There are also heating elements on the inlet and outlet of the pump.
Isolator: The isolator wall is 100 mm thick and is made of ceramic fiber fabric.
Main body: The main cover contains five doors to access the control units, reservoir, pump and 5 bar mechanism. This cover is made of carbon fiber to achieve high strength and light weight.
Indicators: There are four indicators on the four corners. 1) Indicator for the sealant level and 2) temperature, 3) the percentage of the accomplished area and 4) battery level.
Control unit low voltage: This control unit has the main controller, the motors driver, GPS, IMU module, lidars connectors, temperature sensor and cooling system. This unit uses 24 v, 12 v and 5 v. It also has a monitor to display the temperature of the unit to avoid overheating.
Control unit high voltage: This control unit has the main controller, contactors, relays, thermal wires, and fuses. This unit uses a high voltage of 220 v with high current.
Lidar: There are four lidars on the four corners to scan the area around the RoboVehicle
Five-bar robot: Parallel robot that is used to guide the nozzle on the crack.
Nozzle: This tube is connected to the pump with shoe in the nozzle's end. There is a heating element around the nozzle end.
Wheel unit: There are four-wheel units in the system. Every unit contains two rubber tires, four suspensions to hold the RoboVehicle's weight. The driving system is made of a motor, harmonic gear, and pully. FIG. 12 represents the unit assembly/disassembly view and shows driving parts and the motion sequence from the motor to wheels.

Although the invention has been explained in relation to its preferred embodiment, it is to be understood that many other possible modifications and variations can be made without departing from the spirit and scope of the invention.

What is claimed is:

1. An autonomous system for detecting and sealing cracks in road surfaces, comprising:
a ground-based robotic vehicle configured to perform sealing operations;
an aerial drone configured to scan a designated work area;
a scanning subsystem operable on either the aerial drone or the robotic vehicle, the subsystem comprising:
an area scanning module configured to receive coordinates defining a polygonal work area and generate an optimized scan path;
a camera for capturing high-definition images of the road surface;
a crack detection module comprising a deep learning model trained to identify cracks in the captured images;
a crack localization module configured to determine the position of detected cracks in a world coordinate frame and generate a crack map;
a sealing subsystem integrated with the robotic vehicle, comprising:
a path planning module configured to generate an optimized sealing path based on the crack map;
a volume calculation module configured to estimate the volume of each crack using depth imagery;
a cleaning module configured to remove debris from the cracks;
a sealing module comprising a five-bar mechanism and a flexible nozzle configured to dispense sealant along the crack centerline;
an AI-Verify module comprising a deep learning model configured to verify sealing quality and initiate corrective actions;
an analysis system comprising:
a cloud storage module configured to store operational data including road images, sensor data, and robot logs;
a data preparation module configured to clean and preprocess raw data for analysis;
a model training module configured to periodically retrain crack detection and verification models;
a performance analysis module configured to monitor system performance and detect faults;
a road condition analysis module configured to assess road surface condition and predict lifespan;
a port module configured to interface with the robotic vehicle for automated sealant refilling, comprising:
a control unit with GPS, IMU, and microcontroller for docking and flow control;
indicators for docking state, system status, and filling metrics;
a filling port with a docking mechanism;
a station comprising a sealant reservoir and port, configured to wirelessly communicate with the robotic vehicle and optionally retrofitted from existing crack melters;
wherein the robotic vehicle comprises:
a human-machine interface for user interaction and area selection;
a sealant reservoir with integrated agitation and dual-stage heating elements;
a wireless charging landing point for the aerial drone;
a low-voltage control unit and a high-voltage control unit for system management;
a plurality of lidar sensors for environmental scanning;
a plurality of wheel units each comprising dual tires, suspension, and a motorized drive system;
indicators for sealant level, temperature, battery status, and area coverage;
and wherein the aerial drone comprises:
a control unit for autonomous navigation and image analysis;
a battery with wireless charging capability;
a camera with integrated lighting;
a carbon fiber chassis and four propellers for flight control.

2. The system of claim 1, wherein the scanning subsystem adjusts the drone's flight height based on weather and lighting conditions.

3. The system of claim 1, wherein the crack localization module uses triangulation and kinematic transformations to determine 3D crack positions.

4. The system of claim 1, wherein the path planning module ranks cracks based on length and connectivity using a graph-based cost function.

5. The system of claim 1, wherein the sealing module uses a five-bar mechanism to guide the nozzle along the crack centerline.

6. The system of claim 1, wherein the AI-Verify module uses a rear-mounted HD camera to monitor sealing quality and trigger resealing operations.

7. The system of claim 1, wherein the analysis system stores image data in object storage, telemetry in time-series databases, and structured logs in relational databases.

8. The system of claim 1, wherein the port module calculates and displays the volume of sealant dispensed during each refill operation.

9. The system of claim 1, wherein the station includes temperature and level sensors for monitoring sealant status.

10. The system of claim 1, wherein the drone wirelessly charges from the ground-based robotic vehicle during operation.

11. The system of claim 1, wherein the ground-based robotic vehicle's reservoir includes a cone-shaped outlet and heating elements on the pump inlet and outlet.

12. The system of claim 1, wherein the ground-based robotic vehicle's wheel units include harmonic gears and pulleys for motion transmission.
